(19) United States
(12) Patent Application Publication
(10) Pub. No.: US 2005/0071044 A1
(43) Pub. Date: Mar. 31, 2005

(54) Bulk labeling method

(76) Inventors: James A. Yonge, Penn Yan, NY (US); Marc F. Oosterlinck, Upland, CA (US)

Correspondence Address: Warner Norcross & Judd LLP;Intellectual Property Practice Group, 900 Fifth Third Center, 111 Lyon Street, N.W., Grand Rapids, MI, 49503-2487, US

(21) Appl. No.: 10/674,167

(22) Filed: Sep. 29, 2003

(51) Int. Cl. G06F 7/00

(52) U.S. Cl. 700/215; 700/216; 700/231

(57) ABSTRACT

A method for authenticating the contents of containers. The method utilizes a security label including a removable piggyback label having an authentication feature. The method generally includes: obtaining a bulk container with contents stored therein, the container labeled with the security label and the authentication feature indicative of the contents; transferring at least a portion of the contents from the bulk container to a consumer container; and transferring the piggyback label having the authentication feature to the consumer container to verify the authenticity of the transferred contents. This method is useful when transferring pharmaceutical products from a bulk container to individual consumer containers because consumers can be confident that the pharmaceuticals stored by their containers are authentic.

### BACKGROUND OF THE INVENTION

The present invention relates to labeling, and more particularly to labeling for verification of product authenticity.

In the pharmaceutical industry, counterfeit and mislabeled drugs can pose a serious threat to consumer health, and can stifle the innovation of legitimate pharmaceutical companies. For example, consumers often have adverse—and in some cases, life-threatening—reactions when they consume counterfeit drugs that are less potent or of a different composition than the legitimate drugs they were prescribed.

Even more serious health consequences may result when a consumer drug container is mislabeled. Mislabeling occurs more frequently than expected because drugs are dispensed from large, pharmaceutical manufacturer labeled containers to smaller, unlabeled individual containers. A pharmacist, in turn, must print and create a new label for the individual container. On a busy day, or when the pharmaceutical manufacturer label is confusing, it is easy for the pharmacist to print erroneous information on the newly created label.

Furthermore, where drug packaging is intentionally mislabeled, legitimate pharmaceutical manufacturers are deprived of the revenue to which they are entitled. Over time, excessive counterfeiting can produce a significant disincentive for creating new pharmaceutical products.

Several attempts have been made to address mislabeling and counterfeiting. One such attempt is described in U.S. Pat. No. 6,533,180 to Wood, which discloses a security label including a tamper-evident piggyback label. In the context of automotive part packages, Wood provides that after a genuine automotive part is consumed, the piggyback label is removed from the part's original package to reveal a mark on the security label, indicating that the packaging no longer contains the genuine part. The piggyback label is then placed on a document, such as a work order and/or a service log to verify that the genuine part was consumed. In the context of pharmaceuticals, Wood explains that a healthcare worker places a piggyback label on a patient's records to show that the proper drug was administered to the patient.

Although the Wood security label prevents genuine packaging from being reused for counterfeit parts, it fails to provide a way to verify that the parts used were authentic if the piggyback-labeled document is lost, which occurs frequently because the document is dissociated from the part. Likewise, if a patient's records are misplaced, it is difficult to verify that specific drugs were administered.

### SUMMARY OF THE INVENTION

The aforementioned problems are overcome in the present invention comprising a method for authenticating the contents of containers. The method utilizes a security label including a removable piggyback label having an authentication feature. In one embodiment, the method generally includes: obtaining a bulk container with contents stored therein, the container labeled with the security label; transferring at least a portion of the contents from the bulk container to a consumer container; and transferring the piggyback label having the authentication feature to the consumer container to verify the authenticity of the transferred contents.

In one aspect of the embodiment, the security label includes an expanded content device including at least one fold-out page. One or more piggyback labels are removably attached to the page. A user of the piggyback label may access the piggyback labels by folding out the page, or otherwise manipulating the expanded content device.

The present invention is useful when transferring pharmaceutical products from a bulk container to individual consumer containers because, by confirming the presence of the piggyback label and associated authentication feature, pharmacists and/or consumers can be confident that the pharmaceuticals stored in the individual containers are authentic.

These and other objects, advantages and features of the invention will be more readily understood and appreciated by reference to the detailed description of the invention and the drawings.

### BRIEF DESCRIPTION OF THE DRAWINGS

FIG. 1 is a perspective view of a bulk container labeled with a security label of the present invention;

FIG. 2 is a sectional view of the security label;

FIG. 3 is a schematic diagram illustrating a process of the present invention;

FIG. 4 is a sectional view of an alternative embodiment of the security label; and

FIG. 5 is a perspective view of the security label.

### DETAILED DESCRIPTION OF THE INVENTION

I. Security Label Construction

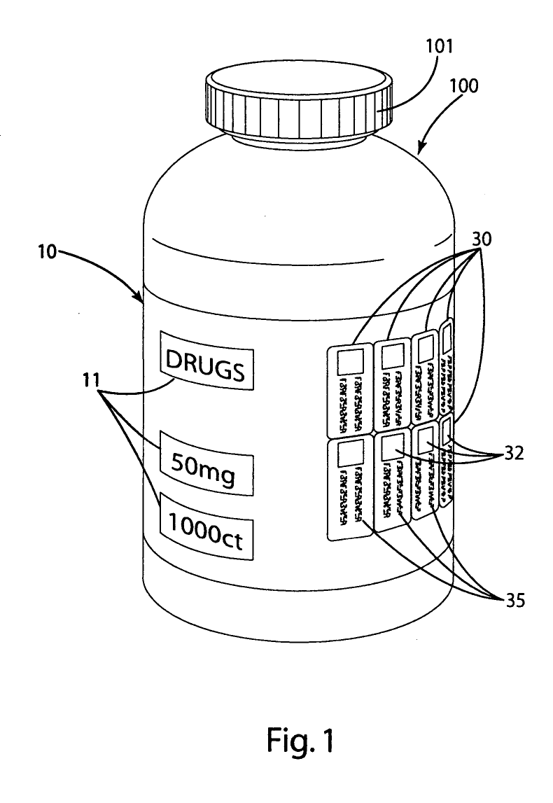

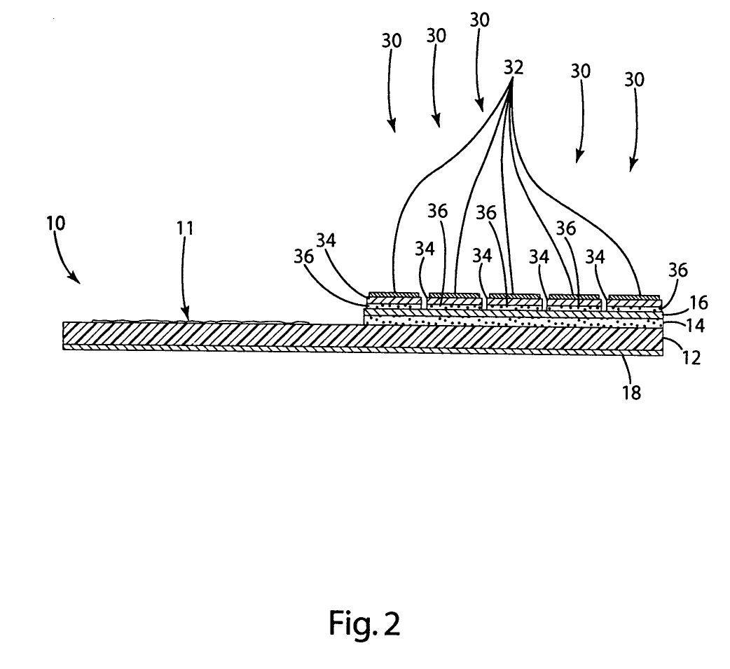

A security label constructed in accordance with an embodiment of the invention is illustrated in FIGS. 1 and 2 and generally designated 10. The security label includes one or more individual piggyback labels 30, each optionally including one or more authentication features 32. The label is secured to a bulk container 100. Although the container shown is a conventional container that contains material, the term “container” as used herein refers to storage devices that store materials and/or products in an interior of the device, as well as devices that store material and/or products partially or fully outside the device.

Referring now to FIG. 2, the security label 10 includes a primary label 12 constructed of conventional label stock. The label stock may be constructed of paper, plastic, synthetic resin, metal, foil, or any other suitable material. Disposed on the underside of the primary label 12 is a first adhesive 18, which is of sufficient peel strength to secure the security label 10 to the bulk container 100. In one embodiment, the adhesive 18 is a pressure-sensitive adhesive, however other adhesives or cements may be used as desired.

The primary label 12 may also include an information field 11 consisting of information such as a product identifier, a manufacturer name, the lot number of the contents of the bulk container to which the label is adhered, a number of units of product in the bulk container, a number of units of the contents that are transferable to a second container, a mass, a volume, an expiration date, or any other useful information. The information fields used herein may be applied by hand or with a mechanical apparatus and can include words, symbols, numbers, barcodes, patterns, colors or other information as desired.

A second adhesive layer 14 secures a release liner 16 to the primary label 12. The adhesive may be of any type suitable for holding the release liner in place. The release liner may include tamper-evident indicia (not shown) that is revealed when the liner is exposed. Optionally, however, the release liner 16 and second adhesive layer 14 may be substituted with a release agent (not shown) associated with the primary label 12. The piggyback labels 30 may be removably disposed on the release agent.

As shown in FIG. 2, one or more piggyback labels 30 are disposed on the release liner 16. The piggyback labels collectively may be of the same dimension and therefore occupy the same space as the release liner 16 to provide a clean appearance. Each piggyback label may include a label base 34 removably secured to the release liner with the third adhesive 36. The piggyback label base 34 may be constructed of paper, plastic, synthetic resin, metal, foil or any other suitable material. Each piggyback label 30 may further include a piggyback label information field 35 which includes any of the information recited above in the information field 11 of the primary label 10. Although the security label illustrated includes multiple piggyback labels, it is to be understood that any number of piggyback labels may be used.

The piggyback labels 30 include an authentication feature 32, which, as shown, is visible on the exterior of the piggyback label. The authentication feature 32 of the present invention may be any feature or combination of features that facilitates authentication of articles labeled with the piggyback label by overt, covert or forensic inspection. For example, the authentication feature may be a unique, fine-print layer, a microchip, a barcode, an ink, a coating, a unique number, a lenticular construction or the like. The authentication feature may also be any diffractive or holographic layer. As used herein, “diffractive layer” means a layer which exhibits an optical diffractive effect when exposed to light. Such diffractive layers and holographic layers resist unauthorized photocopy duplication of the security label and/or piggyback label to provide an extra measure of security. Suitable diffractive layers and holographic layers are described in U.S. Pat. No. 6,533,180 to Wood, which is hereby incorporated by reference. As will be understood, any of the above authentication features may also be placed in whole or in part on the primary label.

II. Manufacture and Use

The security labels 10 are fabricated from a continuous web (not shown) using conventional techniques. The piggyback label 30 are likewise manufactured from a continuous web and precut as individual labels. The piggyback labels 130 are secured to each respective primary label at spaced locations, and preferably, regularly spaced locations. The authenticating features may be secured to the piggyback labels 30 before, after or as the piggyback labels are joined with the primary labels. Indicia is printed on the primary and/or piggyback labels with conventional printing techniques.

Once manufactured, a security label 10 of the invention is applied to a container 100 to indicate the contents of the container. The container 100 may be large plastic bulk container adapted to hold a large bulk quantity of pharmaceutical products, such as pills, tablets, capsules, powder or liquid. Typically, the manufacturer of the pharmaceutical or other contents of the container applies the label before or after filling the container with the contents. After the container is filled in bulk, a cap 101 is applied to secure the pharmaceutical products in the container 100. The filled bulk container is shipped to a pharmacy and entered into inventory.

In one embodiment of the invention, a pharmacist or other licensed dispenser of pharmaceutical products obtains a prescription from patient's health care provider. The pharmacist reviews the prescription and determines the appropriate pharmaceutical product to supply to the patient. The pharmacist then reviews the inventory of bulk pharmaceutical products stored in bulk containers at his disposal. The pharmacist may consult the information field 11 provided on the security labels 10 to confirm the contents of each respective bulk container 100.

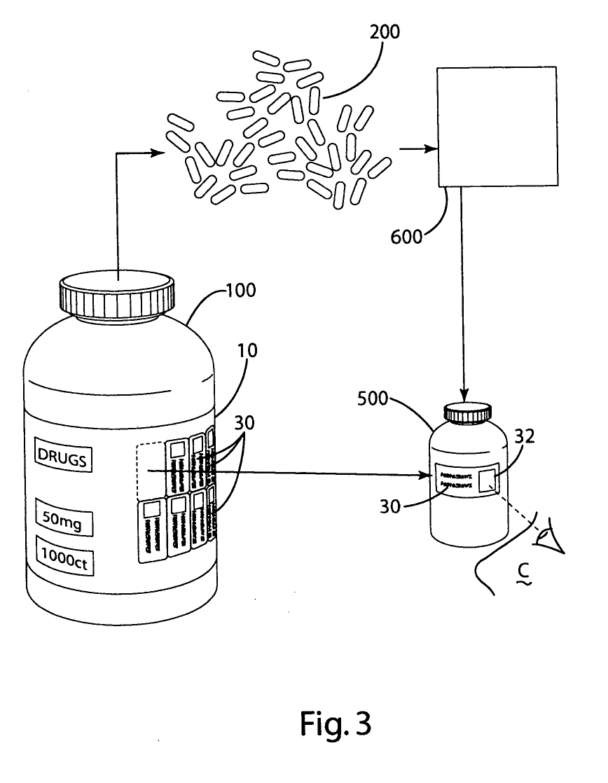

With reference to FIG. 3, the pharmacist obtains the bulk container 100 that contains the drug identified in the prescription. The pharmacists removes a portion of the drugs, for example, a number of tablets 200, from the bulk container. The pharmacist weighs, counts, measures the volume or otherwise evaluates the portion of the pharmaceutical products removed from the bulk container to ensure the quantity and/or mass matches that of the prescription. Such measurement may be conducted using conventional apparatus such as scale, counters or volumetric measuring devices 600.

In another step, the pharmacist obtains a second container 500, which in most cases is smaller than the bulk container 100 because it is required to hold to contain less product. The pharmacist transfers the pharmaceutical product 200, to the second container.

Before or after this transfer, the pharmacist accesses the security label 10 on the bulk container 100. Where the security label 10 includes an expanded content device of the alternative embodiment described below, the pharmacist may open the expanded content label to access one or more piggyback labels for transfer to the container 500. As desired, the security label may include instructions for the user to access the piggyback labels and/or how to place the labels on the consumer container.

The pharmacist removes one or more piggyback labels 30 and transfers it to the consumer container 500. Upon removal of a piggyback label 30 from the primary label, a tamper-evident feature present on the primary label or in the release liner may be exposed, as explained in further detail below.

As described above, the piggyback label includes an authentication feature 32 which, of course, is transferred with the piggyback label to the secondary consumer container 500. The pharmacist may then secure the contents of the container 500 by placing a top or otherwise sealing the secondary container 500.

With the container labeled with the piggyback label 330, a consumer C or other person may confirm that the drugs contained within the secondary container 500 are authentic and/or genuine, that is, that the pharmaceutical contents of the container 500 are exactly what they say they are. Moreover, one can be certain that the contents of the second container 500 were transferred from a bulk container that contained genuine pharmaceutical products supplied directly by the pharmaceutical product manufacturer or intermediaries.

Optionally, where pharmaceutical products are dispensed in consistent, known increments from the bulk container 100, the release liner may include indicia that represents the remaining number or volume of pharmaceutical products in the bulk container. Accordingly, when a piggyback label is removed, a message appears to the remover that a certain amount of product remains in the container 100. In turn, this assists the pharmacy in determining when it will be necessary to reorder pharmaceutical product.

III. Alternative Embodiment

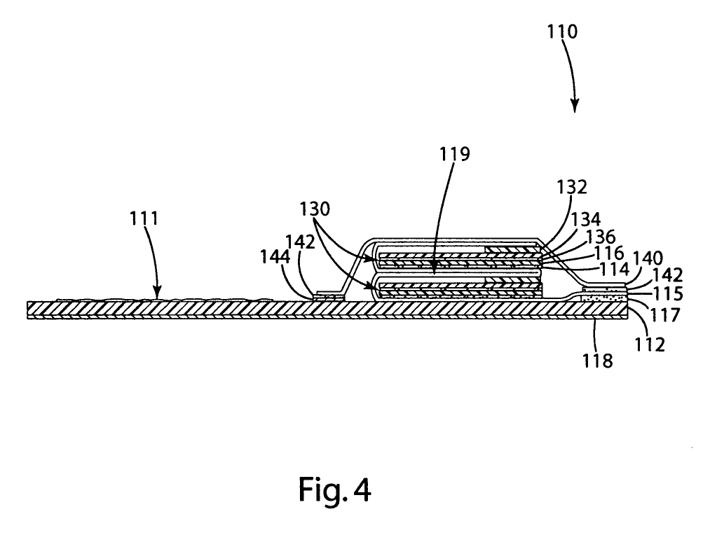

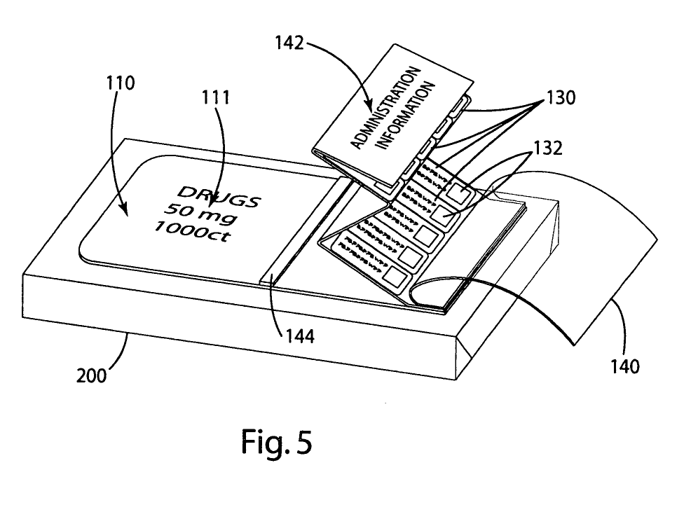

An alternative embodiment of the present invention will now be described with reference to FIGS. 4 and 5, which illustrate an expanded content security label 110 including an expanded content device. An “expanded content device” means any booklet, pamphlet or construct of single or multiple leaflets, or formed as a single page or a number of pages, or a single panel or a number of panels, regardless of whether the leaflets are bound or unbound or folded relative to one another. The leaflets or pages or panels may be printed with any indicia including text or graphics of any kind.

As shown, the expanded content security label 110 includes a map-like, expanded content device 119, however, the expanded content device may open like the pages of a book, or any other configuration that makes accessing the piggyback labels or viewing information that is optionally included on the expanded content device 119.

The expanded content security label 110 also includes a primary label 112 having an adhesive on its underside. this adhesive may be identical to that in the embodiment described above. A folded-over primary panel 115 is secured to the primary label 112 with an adhesive 117. In any configuration desired, the piggyback labels 130 are secured to the panel 115, or where multiple pages are used, the piggyback labels may be secured to one or more of the individual pages. These piggyback labels may be substantially the same as those described in the embodiment above. For example, each piggyback label 13 may include a base 134 secured to a release liner 116 with an adhesive 136, and authentication feature 132.

An overlaminate 140 overlays the booklet 119, which includes the piggyback labels 130 secured thereto. The overlaminate is secured to the panel 115 with an adhesive 142 along at least one side. On another side, the overlaminate 140 is secured to a release coating 24 on or adjacent the primary label 112. This release coating 24 provides excellent sealing and resealing characteristics, whereby the booklet 119 may be accessed many times while still being resealable by adhering the overlaminate 140 to the release coating with adhesive 142. As shown in FIG. 5, the overlaminate 140 is transparent so that information field 142 on the uppermost portion of the leaflet is visible. Optionally, the overlaminate 140 may be opaque.

As will be understood, the overlaminate 140 may be secured to the primary label base 112 in any manner desired. Optionally, the primary panel 115 may be adhered directly to the primary label base 112. In this configuration, the overlaminate is adhered directly to the primary label base 112 as well. Furthermore, the overlaminate need not be resealable. For example, the overlaminate may include perforated marginal portions so that the bulk overlaminate can be torn from the marginal portions to expose the booklet 119.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A method for filling a prescription with at least a portion of pharmaceutical contents stored in a bulk container, comprising:
transferring pharmaceutical contents from the bulk container to a consumer container, the bulk container being labeled with a security label, the security label including a primary label adhered to the bulk container and a piggyback label having an identification feature, the piggyback label removably secured to the primary label;
removing the piggyback label from the bulk container;
applying the piggyback label to the consumer container so that the consumer container is labeled with the identification feature, wherein the identification feature enables a consumer to confirm that the contents of the consumer container are authentic.

2. The method of claim 1 comprising reviewing a prescription for a pharmaceutical product, the pharmaceutical product identical to the pharmaceutical contents of the bulk container.

3. The method of claim 2 wherein the prescription prescribes a number of units of the pharmaceutical product, and wherein the transferring step includes transferring the number of units from the bulk container to the consumer container.

4. The method of claim 1 wherein the security label includes an expanded content device including a page.

5. The method of claim 4 wherein the piggyback label is secured to the page.

6. The method of claim 5 comprising accessing the piggyback label by folding the page out from the expanded content device.

7. The method of claim 1 wherein the security label includes indicia chosen from the group consisting of a lot number, a number of units of pharmaceutical product in the bulk container, a number of units of pharmaceutical product transferable to the consumer container, a mass, a volume, an expiration date, a product identifier and a manufacturer.

8. A method for filling containers, comprising:
obtaining a first container including contents associated therewith, said first container labeled with a primary label including a piggyback label having an authentication feature;
obtaining a second container that is substantially empty;
transferring at least a portion of the contents from the first container to the second container;
transferring the piggyback label having the authentication feature to the second container to verify the authenticity of the transferred contents.

9. The method of claim 8 wherein the contents are pharmaceutical products and comprising quantitatively measuring the pharmaceutical products before said content transferring step.

10. The method of claim 9 wherein said quantitatively measuring includes at least one of weighing, counting, and measuring the volume of said pharmaceutical products.

11. The method of claim 8 wherein said primary label includes instructions for removing the piggyback label and transferring it to the second container.

12. The method of claim 8 wherein the security label includes an expanded content device including a page.

13. The method of claim 12 wherein the piggyback label is secured to the page.

14. The method of claim 13 comprising accessing the piggyback label by folding the page away from the bulk container.

15. The method of claim 8 wherein at least one of primary label and the piggyback label includes indicia chosen from the group consisting of a lot number, a number of units of pharmaceutical product in the first container, a number of units of pharmaceutical product transferable to the second container, a mass, a volume, an expiration date, a product identifier and a manufacturer.

16. A method of supplying pharmaceutical containers, comprising:
labeling a bulk container adapted to store a first supply of pharmaceutical products with a security label, the security label including a primary label adhered to the bulk container and a plurality of piggyback labels, each piggyback label having an authentication feature and removably secured to the primary label;
providing the labeled bulk container to a user, the user having access to a plurality of secondary containers adapted to store a second supply of pharmaceutical products, said second supply less in at least one of quantity of units, volume, and weight than the first supply;
instructing the user to transfer at least one of the piggyback labels to at least one of the secondary containers when at least a portion of the first supply of pharmaceutical products is transferred from the bulk container to the secondary container, wherein the piggyback label transferred to the secondary container confirms for a subsequent consumer that the pharmaceutical products in the secondary container are authentic.

17. The method of claim 16 wherein at least one of primary label and the piggyback label includes indicia chosen from the group consisting of a lot number, a number of units of pharmaceutical product in the bulk container, a number of units of pharmaceutical product transferable to the secondary container, a mass, a volume, an expiration date, a product identifier and a manufacturer.

18. The method of claim 16 wherein the primary label includes an expanded content device.

19. The method of claim 18 comprising instructing the user to open the expanded content device to access the piggyback labels.
